(19) United States
(12) Patent Application Publication
(10) Pub. No.: US 2026/0233604 A1
(43) Pub. Date: Aug. 13, 2026

(54) VEHICLE CONTROL DEVICE AND METHOD

(71) Applicants: Hyundai Motor Company, Seoul (KR); Kia Corporation, Seoul (KR)

(72) Inventors: Jin Kwon KIM, Hwaseong-Si (KR); Jung Woo HAN, Hwaseong-Si (KR)

(21) Appl. No.: 19/382,850

(22) Filed: Nov. 7, 2025

(30) Foreign Application Priority Data
Feb. 11, 2025 (KR) 10-2025-0017121

(51) Int. Cl. B60K 35/22; B60W 30/165; B60W 30/18; B60W 50/14; B60W 60/00

(52) U.S. Cl. CPC B60K 35/22; B60W 30/165; B60W 30/18163; B60W 50/14; B60W 60/001; B60K 2360/167; B60K 2360/175; B60K 2360/188; B60W 2050/146

(57) ABSTRACT

A vehicle control device for a vehicle is provided. The vehicle control device may include a display device; one or more sensors configured to obtain vehicle driving information about the vehicle and external object information about an external object; one or more processors; and a memory storing at least one instruction. The at least one instruction may be configured to cause the vehicle control device to: determine, based on the vehicle driving information and the external object information, that a probability score indicating likelihood of the external object interfering with a driving path of the vehicle is above a threshold value; determine, based on the probability score being above the threshold value, a vehicle control strategy of the vehicle; and display, via the display device and based on the vehicle control strategy, a planned autonomous driving path of the vehicle.

### CROSS-REFERENCE TO RELATED APPLICATION

This application claims priority to and the benefit of Korean Patent Application No. 10-2025-0017121, filed in the Korean Intellectual Property Office on February 11, 2025, the disclosure of which is incorporated herein by reference in its entirety.

### TECHNICAL FIELD

The present disclosure relates to a vehicle control device and method.

### BACKGROUND

As autonomous vehicle technology advances, the technology that allows vehicles to plan their own driving paths and handle interactions with nearby objects while driving is becoming important. Autonomous vehicles may display the driving paths and objects of interest (e.g., objects to follow or avoid) on a map to visually convey intentions of an autonomous driving system to drivers. An autonomous driving system may provide information on, for example, a current driving path of a vehicle and/or specific objects of interest, but one of the limitations of such a system may be that the information provided to the driver might not be intuitive to understand or not enough to convey how appropriately the autonomous driving logic has planned the path based on a surrounding environment.

The matters described in this Background section are only for enhancement of understanding of the background of the disclosure, and should not be taken as acknowledgement that they correspond to prior art already known to those skilled in the art.

### SUMMARY

Various aspects is directed to providing a vehicle control device and method capable of intuitively displaying a control strategy of an autonomous vehicle.

The present disclosure is also directed to providing a vehicle control device and method capable of determining a driving strategy of a vehicle by considering interference of an external object and visually displaying the determined driving strategy.

The present disclosure is also directed to providing a vehicle control device and method capable of updating and displaying a driving strategy of a vehicle in real time when the driving strategy is changed.

According to one or more example embodiments of the present disclosure, a vehicle control device for a vehicle may include: a display device; one or more sensors configured to obtain vehicle driving information about the vehicle and external object information about an external object; one or more processors; and a memory storing at least one instruction. The at least one instruction may be configured, when executed by the one or more processors communicating with the memory, to cause the vehicle control device to: determine, based on the vehicle driving information and the external object information, that a probability score indicating likelihood of the external object interfering with a driving path of the vehicle is above a threshold value; determine, based on the probability score being above the threshold value, a vehicle control strategy of the vehicle; and display, via the display device and based on the vehicle control strategy, a planned autonomous driving path of the vehicle.

The external object information may include movement information about the external object. The at least one instruction may be configured, when executed by the one or more processors communicating with the memory, to further cause the vehicle control device to: determine, based on an object type of the external object and based on the movement information about the external object, an expected movement path of the external object.

The at least one instruction may be configured, when executed by the one or more processors communicating with the memory, to further cause the vehicle control device to: determine, based on the expected movement path of the external object and the vehicle driving information, the probability score.

The at least one instruction may be configured, when executed by the one or more processors communicating with the memory, to cause the vehicle control device to display the planned autonomous driving path of the vehicle by: determining, based on the expected movement path of the external object and the vehicle control strategy, at least one of an area, color, contrast, brightness, shape, or chroma of the planned autonomous driving path being displayed via the display device.

The at least one instruction may be configured, when executed by the one or more processors communicating with the memory, to cause the vehicle to display the planned autonomous driving path of the vehicle by: adjusting, based on updated external object information about the external object, the expected movement path of the external object; modifying, based on the adjusted expected movement path of the external object, the vehicle control strategy; and adjusting, based on the modified vehicle control strategy, at least one of an area, color, contrast, brightness, shape, or chroma of the planned autonomous driving path being displayed via the display device.

The at least one instruction may be configured, when executed by the one or more processors communicating with the memory, to cause the vehicle to determine the vehicle control strategy of the vehicle by: determining the vehicle control strategy further based on the expected movement path of the external object and the vehicle driving information.

The at least one instruction may be configured, when executed by the one or more processors communicating with the memory, to cause the vehicle to determine the vehicle control strategy by: determining at least one of: whether to perform lateral control of the vehicle,

whether to overtake the external object, or whether to follow the external object.

The at least one instruction may be configured, when executed by the one or more processors communicating with the memory, to cause the vehicle to determine the vehicle control strategy by: determining at least one of: a first vehicle control strategy including following the external object without performing lateral control of the vehicle, a second vehicle control strategy including overtaking the external object without performing the lateral control of the vehicle, a third vehicle control strategy including following the external object and performing the lateral control of the vehicle, or a fourth vehicle control strategy including overtaking the external object and performing the lateral control of the vehicle.

The at least one instruction may be configured, when executed by the one or more processors communicating with the memory, to cause the vehicle to determine the vehicle control strategy by: adjusting, based on at least one of a road speed limit or a traffic regulation, the vehicle control strategy.

The at least one instruction may be configured, when executed by the one or more processors communicating with the memory, to cause the vehicle to determine the vehicle control strategy by: adjusting, based on a driving purpose associated with the vehicle, the vehicle control strategy.

According to one or more example embodiments of the present disclosure, a method performed by an apparatus of a vehicle may include: obtaining, via one or more sensors of the vehicle, vehicle driving information about the vehicle and external object information about an external object; determining, based on the vehicle driving information and the external object information, that a probability score indicating likelihood of the external object interfering with a driving path of the vehicle is above a threshold value; determining, based on the probability score being above the threshold value, a vehicle control strategy of the vehicle; and displaying, via a display device and based on the vehicle control strategy, a planned autonomous driving path of the vehicle.

The external object information may include movement information about the external object. The method may further include: determining, based on an object type of the external object and based on the movement information about the external object, an expected movement path of the external object.

The method may further include: determining, based on the expected movement path of the external object and the vehicle driving information, the probability score.

Displaying the planned autonomous driving path of the vehicle may include: determining, based on the expected movement path of the external object and the vehicle control strategy, at least one of an area, color, contrast, brightness, shape, or chroma of the planned autonomous driving path being displayed via the display device.

Displaying the planned autonomous driving path of the vehicle may include: adjusting, based on updated external object information about the external object, the expected movement path of the external object; modifying, based on the adjusted expected movement path of the external object, the vehicle control strategy; and adjusting, based on the modified vehicle control strategy, at least one of an area, color, contrast, brightness, shape, or chroma of the planned autonomous driving path being displayed via the display device.

Determining the vehicle control strategy of the vehicle may include: determining the vehicle control strategy further based on the expected movement path of the external object and the vehicle driving information.

Determining the vehicle control strategy may include: determining at least one of:

whether to perform lateral control of the vehicle, whether to overtake the external object, or whether to follow the external object.

Determining the vehicle control strategy of the vehicle may include: determining at least one of: a first vehicle control strategy including following the external object without performing lateral control of the vehicle, a second vehicle control strategy including overtaking the external object without performing the lateral control of the vehicle, a third vehicle control strategy including following the external object and performing the lateral control of the vehicle, or a fourth vehicle control strategy including overtaking the external object and performing the lateral control of the vehicle.

Determining the vehicle control strategy of the vehicle may include: adjusting, based on at least one of a road speed limit or a traffic regulation, the vehicle control strategy.

Determining the vehicle control strategy of the vehicle may include: adjusting, based on a driving purpose associated with the vehicle, the vehicle control strategy.

### BRIEF DESCRIPTION OF THE DRAWINGS

The objects, features and advantages of the present disclosure will become more apparent to those of ordinary skill in the art by describing one or more example embodiments thereof in detail with reference to the accompanying drawings, in which:

FIG. 1 is a view showing an example vehicle transmitting and receiving data by communicating with other devices;

FIG. 2 is a block diagram showing components of an example vehicle;

FIG. 3 is a flow diagram showing operations of an example vehicle control device;

FIGS. 4, 5A, 5B, 5C, 5D, 6A, 6B, 6C, 7A, 7B, and 7C are views showing example operations of a processor; and

FIG. 8 is a flowchart of an example method of controlling a vehicle.

### DETAILED DESCRIPTION

Hereinafter, one or more example embodiments of the present disclosure will be described in detail with reference to the accompanying drawings.

However, the technical idea of the present disclosure is not limited to some example embodiment(s) to be described but may be implemented in various different forms, and within the scope of the technical idea of the present disclosure, one or more among components in the example embodiment(s) may be used by being selectively combined and substituted.

Further, unless specifically defined and described, terms used in the example embodiment(s) of the present disclosure (including technical and scientific terms) may be interpreted as meanings which are generally understood by those skilled in the art to which the present disclosure pertains, and commonly used terms such as terms defined in dictionaries may be interpreted in consideration of the contextual meaning in the related field.

The terms used in the present disclosure are for the purpose of describing the example embodiment(s) only and are not intended to limit the disclosure.

In the present specification, the singular forms may include the plural forms unless the context clearly dictates otherwise, and when described as “at least one (or one or more) among A, B, and (or) C,” it may include one or more of all possible combinations of A, B, and C. For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

In addition, when describing components of example embodiment(s) of the present disclosure, terms such as first, second, A, B, (a), (b), etc., may be used.

These terms are only for distinguishing the components from other components, and the essence, sequence, or order of the components is not limited by these terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” another component, the term “on (above) or under (below)” includes not only when two components are in direct contact with each other, but also when one or more other components are formed or disposed between the two components. Further, when a component is described as being “on (above) or below (under),” the description may include the meanings of an upward direction and a downward direction based on one component.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., predicting a movement trajectory of an object) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., predicting a movement trajectory of an object) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., predicting a movement trajectory of an object) described herein.

Minimum risk maneuver (MRM) operation(s) may also be controlled, for example, based on one or more features (e.g., predicting a movement trajectory of an object) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., predicting a movement trajectory of an object) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., predicting a movement trajectory of an object) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., predicting a movement trajectory of an object) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), engaging and/or disengaging an autonomous driving mode, etc.). The operation control may further include, for example, displaying the predicted trajectory of an object (e.g., a target vehicle) via a user interface (e.g., a display) to inform an occupant (e.g., a driver) of the vehicle.

The vehicle that an autonomous driving system is actively controlling may be referred to as an ego vehicle, a host vehicle, or an autonomous vehicle. The ego vehicle may also be referred to as a self-driving car, an autonomous car (AC), a driverless car, a robotaxi, a robotic car, or a robo-car. The ego vehicle may be the vehicle that is equipped with the autonomous driving system. Alternatively, the autonomous driving system may control the ego vehicle, for example, from an external and/or remote device, such as a server. The ego vehicle can be partially or wholly controlled (e.g., piloted, driven, etc.) remotely by a remote human driver. A car that is ahead of the ego vehicle (e.g., in the same driving lane as the ego vehicle) may be referred to as a vehicle in front (e.g., a vehicle directly in front), a vehicle ahead (e.g., a vehicle directly ahead), a lead vehicle, a leading vehicle, or a preceding vehicle. A car that follows the ego vehicle (e.g., in the same driving lane as the ego vehicle) may be referred to as a car behind, a trailing vehicle, a following vehicle, or a succeeding vehicle. An adjacent vehicle may refer to any vehicle located in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle that is near the ego vehicle (e.g., within a threshold distance away from the ego vehicle). The target vehicle may be any vehicle that the autonomous driving system monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a vehicle in a different lane than the driving lane of the ego vehicle (e.g., a vehicle to the left, a vehicle to the right, a vehicle in a diagonal direction, etc.), and/or an adjacent vehicle (e.g., regardless of the distance from the ego vehicle and/or regardless of whether there are intervening vehicle(s) between the target vehicle and the ego vehicle). A target vehicle may also be referred to as a surrounding vehicle, a nearby vehicle, an external vehicle, another vehicle (other vehicles), and so forth.

At least in some implementations of an autonomous driving system, in situations where the autonomous vehicle needs to avoid a specific object, there may be various options during an avoidance process. For example, an acceleration or deceleration pattern of a vehicle may vary depending on whether the vehicle decides to avoid an object while simultaneously overtaking the object or the vehicle decides to follow the object after avoiding the object.

However, simply displaying an avoidance object and a driving path may present a problem in that it might be difficult for a driver to intuitively understand the avoidance method selected by the autonomous driving logic.

Such a limitation may prevent the decision-making process of the autonomous vehicle from being clearly conveyed to the driver, and accordingly, the reliability (e.g., as perceived by the driver) in the autonomous driving system may be lowered and driver anxiety may be caused.

Therefore, there exists a need for a technology to more clearly and intuitively visualize and convey, to the driver, the surrounding environmental factors that are being considered by the autonomous driving logic and the resulting path plan and selection process.

Hereinafter, one or more example embodiments will be described in detail with reference to the accompanying drawings, but the same or corresponding components are denoted by the same reference numerals regardless of the drawing numbers, and redundant descriptions thereof will be omitted.

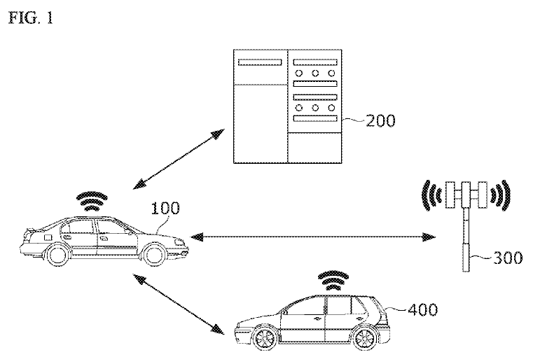

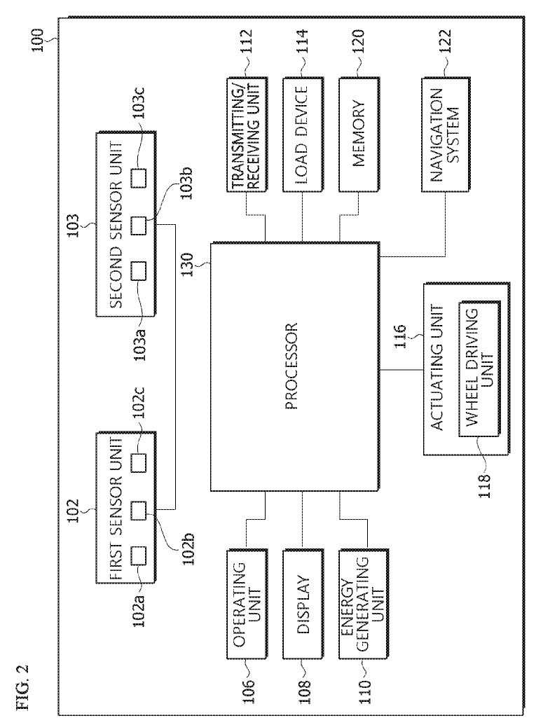

Hereinafter, a vehicle will be described with reference to FIGS. 1 and 2. FIG. 1 is a view illustrating an example vehicle transmitting and receiving data by communicating with other devices.

Referring to FIG. 1, a vehicle 100 may be driven based on electrical energy or fossil energy. In the case of a vehicle driven based on electrical energy, the vehicle 100 may be, for example, a pure battery-based vehicle driven only by a high-voltage battery, or may employ a gas-based fuel cell as an energy source. In addition, the fuel cell may use various types of gas capable of generating electrical energy, and the vehicle 100 may be filled with gas, for example, in a liquefied state. Here, one example of the gas may be hydrogen. However, the gas is not limited thereto, and various gases are applicable. In the case of a vehicle driven based on fossil energy, the vehicle 100 is driven based on fuel such as gasoline, diesel, or liquefied gas, and may be equipped with an internal combustion engine that drives an actuating unit 116 by combustion of the fuel. The engine may be included in an energy generating unit 110 in terms of providing a driving rotational force of wheels to a wheel driving unit 118. As another example, the vehicle 100 may drive the actuating unit 116 by selectively utilizing energy from a fossil energy-based internal combustion engine and an electric battery, and may be a hybrid type vehicle.

The vehicle 100 may refer to a movable device. The vehicle 100 is a ground vehicle that travels on the ground and may be a typical passenger car, a commercial vehicle, a purpose-built vehicle (PBV), or the like. The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, or the like. Here, the ground vehicle may be referred to as any vehicle including a vehicle that moves underground as well as a vehicle that moves over land. The vehicle 100 may be a robot in a broad sense, such as a means of movement, and the robot may move using wheels, tracks, or other movement modules. In the present disclosure, ground mobility devices such as ground vehicles are mainly described, but unless it contradicts the present disclosure, the example embodiment(s) may also be applied to air mobility devices such as an advanced air mobility (AAM), aircraft, or the like, and water mobility devices such as ships, submarines, or the like.

The vehicle 100 may be controlled and driven by autonomous driving, and the autonomous driving may be implemented as semi-autonomous driving or fully autonomous driving. Fully autonomous driving may be provided as autonomous movement in which a processor 130 of the vehicle 100 takes full control without user intervention, even when a driving situation is uncertain. Semi-autonomous driving may be provided as autonomous movement that requires driver intervention depending on specific driving situations. The semi-autonomous driving may be implemented so that the processor 130 transfers control to a user by deactivating autonomous driving when the aforementioned situation occurs, allowing the user to perform manual driving. According to the levels of autonomous driving defined by the Society of Automotive Engineers (SAE), the semi-autonomous driving may correspond to autonomous driving levels 1 to 4, and the fully autonomous driving may correspond to level 5.

Meanwhile, the vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or provided to service autonomous driving, and may receive connected data of the vehicle 100 or transmit data necessary for autonomous driving. The server 200 may transmit various pieces of information and software modules used to control the vehicle 100 to the vehicle 100 in response to requests and data transmitted from the vehicle 100 and the user device to support autonomous driving and various services of the vehicle 100.

The ITS device 300 may be, for example, a roadside unit (RSU), and the ITS device 300 may assist the user in driving his or her host vehicle or support autonomous driving of the vehicle 100 by exchanging vehicle recognition data, driving control and state data, environmental data around the vehicle, map data, or the like, through vehicle-to-infrastructure (V2I) communication with the vehicle 100. The vehicle 100 may support manual driving or autonomous driving by exchanging the data listed herein through vehicle-to-vehicle (V2V) communication with the other vehicle 400.

The vehicle 100 may communicate with other vehicles or other devices based on cellular communication, wireless access in vehicular environment (WAVE) communication, dedicated short range communication (DSRC), short-range communication, or other communication methods.

For example, the vehicle 100 may use a cellular communication network such as Long-Term Evolution (LTE) or 5G, a Wi-Fi communication network, a WAVE communication network, or the like, for communication with the server 200, the ITS device 300, and the other vehicle 400. For another example, DSRC or the like used in the vehicle 100 may be used for communication between vehicles. The communication method between the vehicle 100, the server 200, the ITS device 300, the other vehicle 400, and the user device is not limited to the example embodiment(s) described herein.

FIG. 2 is a block diagram showing components of an example vehicle.

The vehicle 100 may include a sensor unit (also referred to as one or more sensors)102, an operating unit (also referred to as a user interface or an input and output device) 106, a display 108, a load device (also referred to as an electrical load) 114, and a transmitting/receiving unit (also referred to as a communication interface) 112.

The sensor unit 102 may be provided with various types of detectors to detect various states and situations occurring in an external environment, an internal system, a user operation, and a boarding space of the vehicle 100.

Specifically, the first sensor unit 102 may be provided with an externally oriented camera 102a, a lidar sensor 102b, a radar sensor 102c, and the like, to recognize dynamic and static objects present outside the vehicle 100. The camera 102a may recognize an external object as an image while the vehicle 100 is in use, generate image data, and transmit the image data to the processor 130. The lidar sensor 104b may generate point cloud data as recognized data of the external object and transmit the point cloud data to the processor 130 to generate 3D spatial information that identifies at least a shape of the external object. In order to ascertain the presence of an external object and its relative distance, speed, direction, or the like, the radar sensor 102c may emit radio waves of a specific frequency around the vehicle 100 and generate radar data through radio waves considered from the external object. In the present disclosure, the sensor unit is illustrated as having the lidar sensor 102b, but in other examples, the lidar sensor 102b may not be mounted.

The first sensor unit 102 may generate object recognition information based on sensing data. The object recognition information may include information on the presence of an object, position information about the object, information on a distance between the vehicle 100 and the object, and information on a relative speed between the vehicle 100 and the object. The external objects may be various objects related to the operation of the vehicle 100.

A second sensor unit 103 may be provided with a positioning sensor 103a, a wheel sensor 103b, an attitude sensor 103c, and the like, to confirm its own location, speed, driving attitude, and the like. The attitude sensor 103c may include a gyro sensor, an angular velocity sensor, an acceleration sensor, or the like. The attitude sensor may be an inertial measurement unit (IMU) sensor and may be equipped with a 3-axis accelerometer and a 3-axis gyroscope. The attitude sensor 100 may measure acceleration in a traveling direction (x), acceleration in a lateral direction (y), and acceleration in a height direction (z) of the vehicle 100, and a yaw, a pitch, and a roll as the angular velocity of the vehicle.

The second sensor unit 103 may generate vehicle driving information based on sensing data. The vehicle driving information may be information generated based on data detected by various sensors installed inside the vehicle. For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like.

In addition, the vehicle driving information may include path information. The path information may refer to information generated based on a destination input by a vehicle user through the operating unit 106. The path information may refer to information that indicates a traveling path from a current position of a host vehicle to a destination on a map when the destination has been set. When no destination is set, the path information may refer to information including a road on which the host vehicle is currently traveling and a future driving path including the road.

The operating unit 106 may be configured as a module that is controlled by the user for driving. The operating unit 106 may be a user interface, which refers to any device through which a human user (e.g., a driver) can interact with a device, such as the vehicle. The operating unit 106 may thus include an input interface (also referred to as an input device) that can receive an input from the human user and/or an output interface (also referred to as an output device) through which data or information can be output to the human user. An input interface may include, for example, a button, a knob, a toggle, a switch, a dial, a slider, a keyboard, a touchscreen, a control panel, an instrumentation panel, a center console (also referred to as a central console), a microphone, a stalk (e.g., a control stalk), a gear shift control (e.g., a gear stick, a gear stalk, etc.), a camera, a wheel, a steering wheel, a pedal, a lever, etc. An output interface may include, for example, a light (e.g., an indicator light), a lamp, an indicator, a screen, a display, a console, a dashboard, a meter, a gauge, a speaker, etc. Any of the input interfaces described herein may also be an output interface, and vice versa. For example, a center console may be considered both an input interface (e.g., equipped with buttons, knobs, sliders, a touchscreen, etc.) and an output interface (e.g., equipped with a display, indicator lights, etc.). For example, the operating unit 106 may be a steering wheel for manual driving, an automatic or manual shift transmission, an accelerator pedal, a brake pedal, or the like. The operating unit 106 may be further provided with an interface for enabling or disabling an autonomous driving mode and selecting detailed functions requested by the user so that the user may use an autonomous driving function. In order to receive various requests related to autonomous driving, the operating unit 106 may be configured, for example, as a hard-type interface provided at a predetermined position inside the vehicle 100, or as a soft-type interface that may be touched on the display 108. Depending on the specifications of the autonomous vehicle, at least one of the steering wheel, the transmission, and the pedal may be omitted. For another example, the operating unit 106 may be provided with a module that receives a user’s control request for the load device 114 in addition to driving control.

The display 108 may function as a user interface. The display 108 may output and display an operating state, a control state, path/traffic information, remaining energy amount information, content requested by the driver, or the like, of the vehicle 100 by the processor 130. In addition, the display 108 may be configured as a touch screen capable of detecting a driver’s input to receive a driver’s request to instruct the processor 130.

The load device 114 is mounted on the vehicle 100 and may be a type of non-driving electrical device not including a driving power system such as the wheel driving unit 118 or the like. The load device 114 is an auxiliary device that receives electrical power from the energy generating unit 110, and may be, for example, an air conditioning system, a lighting system, a seat system, various devices installed in the vehicle 100, or the like. In the present disclosure, a cooling/heating system that cools or heats at least one of a battery, a fuel cell, an internal combustion engine, an air conditioning system, and a specific part of the vehicle 100 may be further included.

The transmitting/receiving unit 112 may support mutual communication with the server 200, the ITS device 300, the nearby vehicle 400, and the like. The transmitting/receiving unit 112 may include a module that processes, for example, cellular communication, WAVE, DSRC communication, and the like. In the present disclosure, the transmitting/receiving unit 112 may transmit data generated or stored while driving to the server 200 and receive data and software modules transmitted from the server 200. The transmitting/receiving unit 112 may support communication with an electronic device carried by an occupant inside the vehicle 100. In the present disclosure, the vehicle 100 may transmit and receive data utilized in a method according to the present disclosure to and from the outside through the transmitting/receiving unit 112.

For example, the transmitting/receiving unit 112 may receive traffic signal information from a traffic signal controller and provide the traffic signal information to the processor 130. In addition, the transmitting/receiving unit 112 may receive a control signal from the traffic signal controller and provide the control signal to the processor 130.

In addition, the vehicle 100 may include the energy generating unit 110 and the actuating unit 116.

The energy generating unit 110 may generate and supply power and electric power used in a driving power system and a non-driving power system, such as the actuating unit 116. The non-driving power system may be, for example, the sensor unit 102, the operating unit 106, the display 108, the load device 114, and the transmitting/receiving unit 112, but is not limited thereto, and may include various components that implement sensing, interface, communication, and convenience functions, not including components directly involved in driving operations. When the vehicle 100 is driven based on electrical energy, the energy generating unit 110 may be configured as an electric battery charged from the outside, or configured as a combination of an electric battery and a fuel cell that charges the electric battery. In the case of a vehicle driven based on the combination of the electric battery and the fuel cell, the energy generating unit 110 may include a tank that stores materials used to produce electric power for the fuel cell, such as liquefied hydrogen. When the vehicle 100 is driven based on fossil energy, the energy generating unit 110 may be configured as an internal combustion engine. In addition, when the vehicle 100 is a hybrid type (e.g., a hybrid electric vehicle), the energy generating unit 110 may be provided as a combination of the internal combustion engine and the electric battery.

The actuating unit 116 may be provided with at least one module that implements driving operations and perform at least one driving operation among longitudinal control such as acceleration and deceleration and lateral control such as steering, according to a user request from the operating unit 106. In order to perform driving operations according to a command of the processor 130 by manual operation of the user or autonomous driving, the actuating unit 116 may be provided with the wheel driving unit 118 and mechanical components and electronic modules for implementing the driving operations in the wheel driving unit 118. When the vehicle 100 is operated based on electrical energy, the actuating unit 116 may include an assembly for transmitting the requested driving operation to the wheel driving unit 118. When the vehicle 100 is operated based on fossil energy, the actuating unit 116 may be provided with a transmission and a gear module that transmit the power of the internal combustion engine.

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels. When the vehicle 100 is driven based on electrical energy, the driving force generating module may be configured as a motor assembly that generates a driving force based on electric power output from the electric battery. The braking module of the electric-based vehicle 100 may further have a regenerative braking function.

A navigation system 122 may provide navigation information. The navigation information may include at least one of map information, set destination information, path information according to a set destination, information on various objects on the path, lane information, and current vehicle position information.

The navigation system 122 may receive information from an external device through the transmitting/receiving unit 112 and update previously stored information. The navigation system 122 may be classified as a sub-component of the operating unit 106.

In addition, the vehicle 100 may include a memory 120 and the processor 130.

The memory 120 may store applications and various types of data for controlling the vehicle 100, and load applications or read and record data by a request of the processor 130.

The processor 130 may perform overall control of the vehicle 100. The processor 130 may be configured to execute applications and instructions stored in the memory 120.

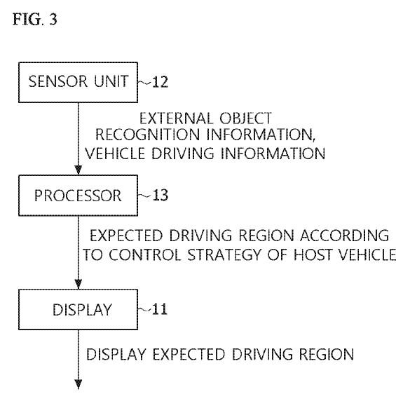

FIG. 3 is a flow diagram showing the operations of an example vehicle control device. Referring to FIG. 3, a vehicle control device 10 may include a display (also referred to as a display device) 11, a sensor unit (also referred to as one or more sensors)12, and a processor 13. The display 11 and the processor 13 in FIG. 3 may have the same configuration as the display and the processor of FIG. 2, respectively. The sensor unit 12 in FIG. 3 may refer to a component including the first sensor unit and the second sensor unit in FIG. 2.

The sensor unit 12 may collect vehicle driving information about a host vehicle and external object recognition information (also referred to as external object information).

As described herein, the external object recognition information may include information on the presence of an object, location information about the object, information on a distance between the vehicle and the object, and information on a relative speed between the vehicle and the object. External objects may be various objects related to the operation of the vehicle.

In addition, the vehicle driving information about the host vehicle may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, vehicle engine temperature information, and the like.

In addition, the vehicle driving information about the host vehicle may include path information. The path information may refer to information generated based on a destination input by a vehicle user through the operating unit. The path information may refer to information that indicates a traveling path from a current position of a host vehicle to a destination on a map when the destination has been set. When no destination is set, the path information may refer to information including a road on which the host vehicle is currently traveling and a future driving path including the road.

The processor 13 may determine an external object expected to interfere with (e.g., intersect or come within a threshold distance from) the driving path of the host vehicle based on the vehicle driving information about the host vehicle and external object recognition information. In other words, the processor 13 may determine that a probability score indicating likelihood of the external object interfering with the driving path of the host vehicle is above a threshold value.

The processor 13 may determine an expected path (e.g., expected movement path) of the external object based on the type (e.g., object type or classification, such as an automobile, a sedan, a sports utility vehicle (SUV), a compact vehicle, a truck, a bus, a motorcycle, a bicycle, a pedestrian, etc.) of the external object and movement information about the external object (e.g., an expected movement path of the object) included in the external object recognition information. For example, the expected path of the external object may be determined depending on a predetermined (e.g., typical or known) movement pattern associated with a specific object type. If, for example, the external object is determined to be a motorcycle, the expected path of the external object may be determined based on a known movement pattern of a typical motorcycle.

In this way, the processor 13 may determine an external object expected to interfere based on the expected path of the external object and the vehicle driving information about the host vehicle.

The processor 13 may estimate a current position by tracking a past position of an external object based on external object recognition information. The processor 13 may continuously observe the current position, speed, direction, and the like of the external object in a moving state and track changes over time.

For example, the processor 13 may predict a future position based on state information about the external object based on a Kalman Filter, an Extended Kalman Filter, or a Particle Filter.

The processor 13 may predict a path on which an external object such as a vehicle or motorcycle is highly likely to travel based on lane information about a road on which the host vehicle is traveling. The processor 13 may perform the path prediction by considering the current speed and direction of the external object, and curvature and continuity of the lane.

The processor 13 may model the behavior of an object that is not restricted by lanes, such as a pedestrian or animal, based on the external object recognition information. For example, a pedestrian tends to follow road rules (e.g., crosswalks, sidewalks), an animal is more likely to exhibit random movements, and the processor 13 may model the behavior of the external object by applying a trained model (e.g., deep learning) based on past data or a rule-based system.

The processor 13 may probabilistically determine multiple paths that the external object may take under various conditions. For example, the processor 13 may generate multi-hypothesis paths to express the uncertainty of the future path and assign a probability value to each path.

The processor 13 may divide the external object into a moving object (e.g., a vehicle, a pedestrian, or an animal) and a static object (e.g., a cone or a guardrail) based on the external object recognition information. The processor 13 may predict a movement path of the moving object based on a current speed, direction, and position of the moving object.

The processor 13 may estimate that the static object maintains its current position.

The processor 13 may determine the expected path of the external object based on the type of the external object and results of behavior modeling.

The processor 13 may estimate that the moving object classified as a vehicle, such as an automobile, a motorcycle, or the like is likely to move along a road lane. In the case of a moving object such as a vehicle, a motorcycle, or the like, the processor 13 may determine the expected path by considering the current speed and direction (heading angle) of the moving object, and the curvature and directionality of a lane.

For example, when a vehicle, which is a moving object, is moving straight, the processor 13 may expect that the moving object will move straight while maintaining the current speed and steering angle and then follow a lane that gradually enters according to the road curvature.

The processor 13 may estimate that a moving object classified as a pedestrian will not follow a lane, but will move while complying with road rules (e.g., using a crosswalk or walking along a sidewalk), and determine the expected path of the external object accordingly.

For example, the processor 13 may estimate that a pedestrian will move along the sidewalk while maintaining the current speed, estimate that, when approaching a crosswalk, the pedestrian will change the direction of movement and cross the road, and determine the expected path of the external object based on the estimation.

The predictions may be made based on a movement pattern of the external object and a road structure (a crosswalk, a sidewalk location, and the like).

The processor 13 may estimate that the external object classified as an animal will move regardless of road rules and determine the expected path of the external object.

For example, the processor 13 may predict a path along which the animal is highly likely to randomly move in a direction in which the animal is currently moving based on results of the behavior modeling determined based on position information detected for a certain period of time in the past of the external object, and give greater uncertainty to the predicted path.

The processor 13 may update the expected path of the external object in real time based on the external object recognition information collected in real time.

The processor 13 may determine a control strategy (also referred to as a vehicle control strategy) of the host vehicle for external object expected to interfere.

The expected path of the external object described herein may refer to a process of predicting a future position based on the current position, speed, and direction data of the external object. The processor 13 may analyze the possibility that the expected path of the external object will enter a driving path of the host vehicle (including a driving lane and a safety zone).

The processor 13 may compare the expected path of the external object with the driving path of the host vehicle to evaluate the possibility that the external object will affect the speed, direction, or control (acceleration, deceleration, and steering) of the host vehicle.

The processor 13 may determine a relative position and timing of the host vehicle and the external object based on the acceleration/deceleration, steering response, speed change, and the like of the vehicle, and, based on the calculation, may establish the control strategy so that the host vehicle may efficiently select a driving path while avoiding interference with the external object.

The control strategy may be defined as a combination of longitudinal control (acceleration/deceleration) and lateral control (steering). In addition, the control strategy may be expressed in the form of following, overtaking, bias driving, lane changing, and the like on the road.

The processor 13 selects the most appropriate control strategy (overtaking or following) under specific conditions to avoid interference and achieve a driving purpose (also referred to as a trip type). For example, the driving purpose may be one of a personal trip, a business trip, an urgent trip (e.g., a trip to an emergency room, a first responder traveling to an emergency site, etc.), a delivery trip (e.g., a truck hauling cargo), etc. The control strategy may be determined based on the type of the trip that is predetermined or set by a user (e.g., driver). For example, a more aggressive form of vehicle control strategy (e.g., prioritizing a shorter path over a more fuel-efficient path) if the user has set the driving purpose to be an urgent trip.

The processor 13 may determine the control strategy based on the expected path of the external object and the vehicle driving information about the host vehicle.

For example, the processor 13 may determine the control strategy by combining whether to perform lateral control, whether to perform overtaking, and whether to perform following, on the external object expected to interfere.

The driving path of the host vehicle may be defined as an additional safety zone that considers the current lane, the width of the host vehicle, and the like.

The processor 13 may determine a case where there is a possibility that the expected path of the external object may enter the driving path of the host vehicle as an interference situation. In the interference situation, the processor 13 may establish the control strategy by analyzing a relative position and speed of the external object and the host vehicle and an expected entry time.

For example, according to the interference situation of the external object, for the external object expected to interfere, the processor 13 may determine a first strategy of following without lateral control, a second strategy of overtaking without lateral control, a third strategy of following by performing lateral control, or a fourth strategy of overtaking by performing lateral control.

The processor 13 may determine the first strategy of following without lateral control when the external object enters an interference region at a point in time earlier than the host vehicle does and the host vehicle is positioned behind the object and needs to follow the external object. For example, the processor 13 may analyze the relative position and speed of the external object and the host vehicle to determine an interference region where interference with the external object is expected and an interference point in time when the interference is expected. When the processor 13 determines that the vehicle may not pass through the interference region before the interference point in time by lateral control and acceleration, the processor 13 may determine the first strategy as the control strategy of the host vehicle. That is, when a point in time when the external object enters the interference region is earlier than a point in time when the host vehicle enters the interference region by a preset first threshold value or more, the processor 13 may determine the first strategy of following without lateral control as the control strategy of the host vehicle. The processor 13 may set the first threshold value based on the relative position and speed of the external object and the host vehicle.

The processor 13 may determine the second strategy of overtaking without lateral control when the host vehicle may pass through the corresponding region before the external object enters the driving path of the host vehicle. For example, the processor 13 may analyze the relative position and speed of the external object and the host vehicle to determine an interference region where interference with the external object is expected and an interference point in time when the interference is expected. When the processor 13 determines that the host vehicle may pass through the interference region before the interference point in time by only accelerating without lateral control, the processor 13 may determine the second strategy of overtaking without lateral control as the control strategy of the host vehicle. That is, when a point in time when the host vehicle enters the interference region is earlier than a point in time when the external object enters the interference region by a preset second threshold value or more, the processor 13 may determine the second strategy of overtaking without lateral control as the control strategy of the host vehicle. The processor 13 may set the second threshold value based on the relative position and speed of the external object and the host vehicle.

The processor 13 may determine a third strategy of following by performing lateral control when the external object and the host vehicle enter the interference region almost at the same time, but the host vehicle is positioned behind the object and needs to follow the object. For example, the processor 13 may analyze the relative position and speed of the external object and the host vehicle to determine an interference region where interference with the external object is expected and an interference point in time when the interference is expected. When the processor 13 determines that the vehicle may not pass through the interference region before the interference point in time by lateral control and acceleration, the processor 13 may determine the third strategy of following by performing lateral control as the control strategy of the host vehicle. For example, the processor 13 may perform a certain level of lateral control to avoid collision with the external object because the points in time when the external object and the host vehicle enter the interference region are almost the same. That is, when the point in time when the external object enters the interference region is earlier than the point in time when the host vehicle enters the interference region and is less than or equal to a preset third threshold value, the processor 13 may determine the third strategy of following by performing lateral control as the control strategy of the host vehicle. The processor 13 may set the third threshold value based on the relative position and speed of the external object and the host vehicle.

The processor 13 may determine a fourth strategy of overtaking by performing lateral control when the external object and the host vehicle enter the driving path of the host vehicle almost at the same time, but the host vehicle may pass through the interference region first by performing lateral control and acceleration in parallel to get ahead of the external object. For example, the processor 13 may analyze the relative position and speed of the external object and the host vehicle to determine an interference region where interference with the external object is expected and an interference point in time when the interference is expected. When the processor 13 determines that the host vehicle may pass through the interference region before the interference point in time by lateral control and acceleration, the processor 13 may determine the fourth strategy of overtaking by performing lateral control as the control strategy of the host vehicle. That is, when the point in time when the host vehicle enters the interference region is earlier than the point in time when the external object enters the interference region and is less than or equal to a preset fourth threshold value, the processor 13 may determine the fourth strategy of overtaking by performing lateral control as the control strategy of the host vehicle. The processor 13 may set the fourth threshold value based on the relative position and speed of the external object and the host vehicle.

In addition, the processor 13 may adjust the control strategy by considering a road speed limit (e.g., posted speed limit) and regulation information (e.g., local traffic regulations).

In addition, the processor 13 may adjust the control strategy by considering a preset driving purpose.

The control strategy may be determined based on driving information about the host vehicle and the expected path of the external object, but may also be determined by considering other conditions and the driving purpose.

For example, the processor 13 may establish the control strategy under conditions of complying with speed limits, traffic regulations, safety distances, and the like according to a road curvature.

In addition, the processor 13 may establish the control strategy by additionally applying conditions such as a minimum jerk profile to maintain ride comfort, an acceleration/deceleration profile considering energy efficiency, and a shortest driving time to a target point.

For example, when determining the second strategy of overtaking without lateral control or the fourth strategy of overtaking by performing lateral control, the processor 13 may select a strategy of following instead of the second strategy or the fourth strategy when the speed required for overtaking exceeds the speed limit of the road.

For example, the processor 13 may select the control strategy in a direction that minimizes jerk on a road with a low speed limit, and may select the control strategy in a direction that reaches a target point in the shortest time on a highway.

The processor 13 may select the most appropriate control strategy and execute acceleration/deceleration and steering control of the host vehicle according to the selected control strategy.

The processor 13 may modify the control strategy by adjusting the expected path of the external object according to the movement information about the external object. For example, the processor 13 may adjust the expected path (e.g., expected movement path) of the external object based on updated external object information about the external object. The processor 13 may modify the control strategy (e.g., vehicle control strategy) based on the updated expected movement path of the external object. That is, the processor 13 may determine the movement information about the external object based on the external object recognition information detected in real time, and maintain or change the current control strategy based on the determined movement information about the external object.

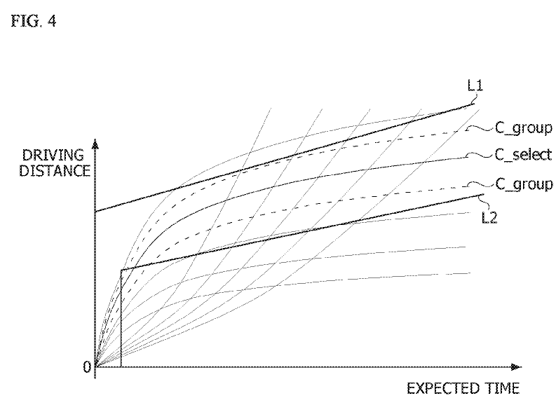

FIG. 4 is a view showing example operations of the processor 13. Referring to FIG. 4, the processor 13 may select the strategy of following without lateral control for a first external object expected to interfere, and determine the strategy of overtaking with lateral control for a second external object. The processor 13 may use the driving information about the host vehicle to select a candidate group of positions of the host vehicle by considering the position conditions L1 of the host vehicle by considering a position condition L1 of the host vehicle for each time period for following the first external object without lateral control based on the driving information about the host vehicle and a position condition L2 of the host vehicle for each time period for overtaking the second external object with lateral control. The processor 13 may determine the amounts of longitudinal control and lateral control of the host vehicle to satisfy the candidate group of positions of the host vehicle and determine a plurality of position curves C_group that match the current driving path of the host vehicle when the host vehicle travels according to the determined control amounts. For example, the processor 13 may select a position curve C_select with the smallest jerk among the plurality of position curves and determine the control amount of the host vehicle according to the selected position curve.

The processor 13 may visually display an expected driving region (also referred to as a planned driving path) in which the host vehicle is determined to travel according to the control strategy through the display 11.

For example, the processor 13 may adjust at least one of an area, color, contrast, brightness, shape, and chroma of the expected driving region according to the expected path of the external object and the control strategy.

In addition, if the control strategy is modified, the processor 13 may adjust at least one of the area, color, contrast, brightness, shape, and chroma of the expected driving region according to the modified control strategy.

The processor 13 may define a space that visually represents a path on which the host vehicle may travel as the expected driving region of the host vehicle. The processor 13 may dynamically generate the expected driving path based on kinematic characteristics of the host vehicle (speed, acceleration, steering angle, and the like), road conditions (lanes, curvature, signals, and the like), and the expected path of external objects.

The processor 13 may exclude the expected path of the external object from the driving region of the host vehicle when there is a possibility that the external object may interfere with the driving path of the host vehicle. For example, the processor 13 may adjust the size and position of the expected driving region to avoid the expected path of the object when the host vehicle overtakes or follows the external object with lateral control. The processor 13 may display the expected driving region except an interference region where interference with the external object is expected in the current driving region of the host vehicle. That is, the processor 13 may adjust the expected driving region so that the driving path of the host vehicle and the expected path of the external object do not overlap.

In addition, the processor 13 may display the expected driving region in different colors depending on an acceleration situation and a deceleration situation of the host vehicle.

The processor 13 may adjust the color when the external object may overlap the driving path of the host vehicle, but when overtaking or following the external object without lateral control. For example, when it is determined that the host vehicle will pass through the interference region without lateral control before the interference point in time with the external object, the processor 13 may differently display the color of the expected driving region depending on the acceleration situation and the deceleration situation of the host vehicle without adjusting the size or position of the current driving region.

For example, when acceleration of the host vehicle is required, the processor 13 may display the color of the driving region brighter or highlight a boundary line to indicate that the host vehicle plans to pass through the driving path through acceleration.

For example, when deceleration or lateral control is required, the processor 13 may adjust the boundary of the driving region to visually highlight a new path.

In addition, the processor 13 may display the color of the expected driving region brightly in a situation where acceleration of the vehicle is required, or adjust the brightness and shape to emphasize a specific condition.

The processor 13 may update the expected driving region in real time according to the movement of the host vehicle and a nearby object. For example, when a vehicle in front suddenly slows down or a new obstacle is detected, the processor 13 may consider the situation and immediately reset the expected driving region.

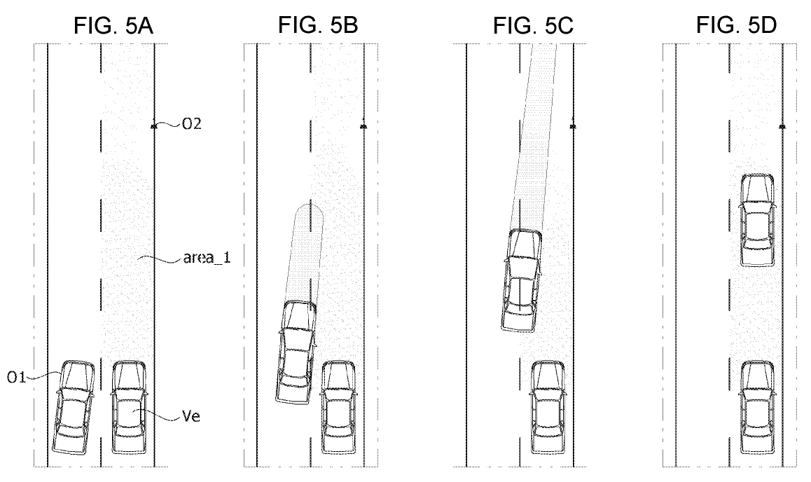

FIGS. 5A, 5B, 5C, 5D, 6A, 6B, 6C, 7A, 7B, and 7C are views showing example control operations of the processor 13.

Referring to FIG. 5A, a host vehicle Ve is traveling by an autonomous driving system, and an external object (hereinafter, an “entering vehicle O1”) is expected to enter a driving path region of the host vehicle Ve. The processor 13 sets an initial control strategy of the host vehicle Ve to overtaking without lateral control, which is a situation in which it is determined that the host vehicle Ve will accelerate and pass through a driving path before the entering vehicle O1. The processor 13 displays an expected driving region area_1 that secures a safe distance from a rubber cone O2 that is a static object in front on the display 11.

Referring to FIG. 5B, the speed of the entering vehicle O1 begins to increase more than that of the host vehicle Ve, and the processor 13 determines that it is difficult for the host vehicle Ve to pass through the path before the entering vehicle O1 without lateral control. The processor 13 changes the control strategy to a strategy of overtaking the entering vehicle O1 through biased driving of the host vehicle Ve to get ahead of the entering vehicle O1. The processor 13 removes an interference region where interference with the entering vehicle O1 is expected from the expected driving region area_1 according to the changed control strategy and displays a new expected driving region area_1. For example, the processor 13 may adjust at least one of the brightness, color, and chroma of the expected driving region area_1 according to a change in an acceleration/deceleration control amount of the host vehicle Ve.

Referring to FIG. 5C, the speed of the entering vehicle O1 increases more than before, so that the processor 13 determines that it is difficult for the host vehicle Ve to overtake the entering vehicle O1. The processor 13 gives up the strategy of overtaking the entering vehicle O1 and changes the control strategy to a strategy of following the entering vehicle O1 with lateral control. The processor 13 additionally removes an interference region where interference with the entering vehicle O1 is expected from the expected driving region according to the changed control strategy and displays a new expected driving region area_1. For example, the processor 13 may adjust at least one of the brightness, color, and chroma of the expected driving region area_1 according to a change in an acceleration/deceleration control amount of the host vehicle Ve.

Referring to FIG. 5D, the speed of the entering vehicle O1 increases more than before, so that the processor 13 changes the control strategy to a strategy of following the entering vehicle O1 even without performing lateral control. For example, the entering vehicle O1 enters the driving path of the host vehicle Ve without affecting the driving of the host vehicle Ve, and therefore, the processor 13 does not adjust the size or shape of the expected driving path of the host vehicle Ve according to the expected path of the entering vehicle O1. However, the processor 13 may adjust at least one of the brightness, color, and chroma of the expected driving region area_1 according to a change in an acceleration/deceleration control amount of the host vehicle Ve.

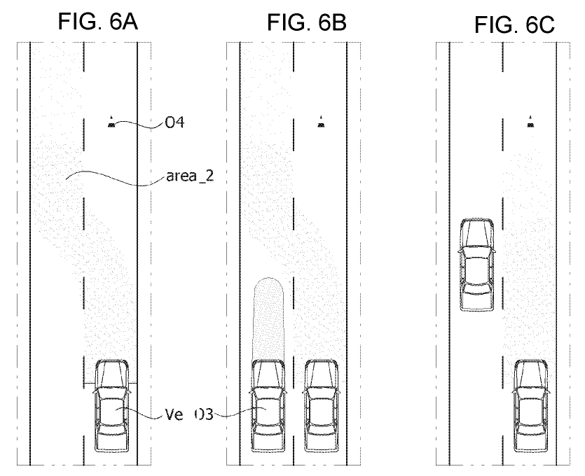

Referring to FIGS. 6A, 6B, and 6C, the processor 13 plans to change a lane of the host vehicle Ve to avoid a rubber cone O4 positioned on the driving path of the host vehicle Ve, and expects an entering vehicle O3 to enter the lane to which the host vehicle Ve is planning to change based on external object recognition information.

In FIG. 6A, the processor 13 sets the control strategy to a strategy of overtaking the entering vehicle O3 without lateral control, and determines that the host vehicle Ve is in a situation capable of accelerating and changing lanes before the entering vehicle O3. Here, the strategy of overtaking without lateral control refers to a strategy for the entering vehicle O3, and lateral control needs to be performed in a lane change process. The processor 13 may display the expected driving path on which the host vehicle Ve is expected to travel through the lane change on the display 11.

In FIG. 6B, the speed of the entering vehicle O3 gradually increases, so that the processor 13 determines that there is a high possibility of interference with the expected driving path of the host vehicle Ve. The processor 13 may detect this and change the control strategy to overtaking with lateral control. In this way, the processor 13 may attempt to complete the lane change before the entering vehicle O3. The processor 13 removes an interference region where interference with the entering vehicle O3 is expected from the expected driving region area_2 according to the changed control strategy and displays a new expected driving region area_2. For example, the processor 13 may adjust at least one of the brightness, color, and chroma of the expected driving region area_2 according to a change in an acceleration/deceleration control amount of the host vehicle Ve.

In FIG. 6C, the speed of the entering vehicle O3 further increases, so that the processor 13 may cancel the lane change and change the control strategy to following without lateral control. The processor 13 modifies the expected driving path (e.g., the planned driving path of the host vehicle) to an existing lane (e.g., the current driving lane of the vehicle) and then controls the host vehicle Ve until the entering vehicle O3 overtakes the host vehicle Ve in the lane to be changed and moves away from the host vehicle by a safe distance or more. Then, the processor 13 may determine the expected driving path to perform the lane change to follow the rear of the entering vehicle O3. The processor 13 may newly set the expected driving region area_2 to follow the rear of the entering vehicle O3 according to the changed control strategy and display the new expected driving region on the display 11. For example, the processor 13 may adjust at least one of the brightness, color, and chroma of the expected driving region area_2 according to a change in an acceleration/deceleration control amount of the host vehicle Ve.

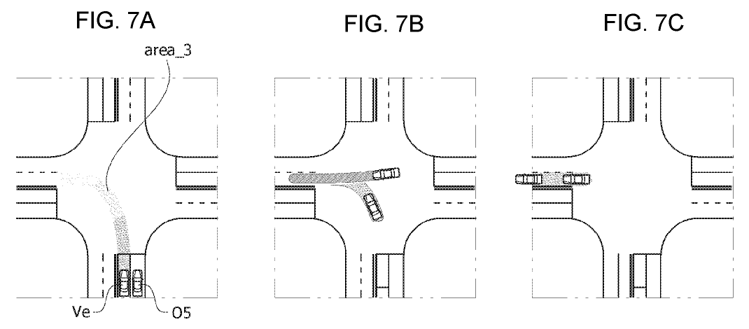

Referring to FIGS. 7A, 7B, and 7C, the host vehicle Ve is passing through an intersection, and an entering vehicle O5 is expected to enter the path of the host vehicle Ve.

In FIG. 7A, the processor 13 determines that the host vehicle Ve will pass through the intersection before the entering vehicle O5 according to the strategy of overtaking without lateral control. The processor 13 may display the expected driving path on which the host vehicle Ve is expected to travel to pass through the intersection on the display 11.

In FIG. 7B, the entering vehicle O5 is approaching the intersection faster than the host vehicle Ve, and the processor 13 determines that it is difficult for the host vehicle Ve to pass through the intersection as initially planned and changes the control strategy to following with lateral control. The processor 13 removes an interference region where interference with the entering vehicle O5 is expected from the expected driving region area_3 according to the changed control strategy and displays a new expected driving region area_3. For example, the processor 13 may adjust at least one of the brightness, color, and chroma of the expected driving region area_3 according to a change in an acceleration/deceleration control amount of the host vehicle Ve.

In FIG. 7C, the speed of the entering vehicle O5 gradually increases, so that the possibility of overtaking the host vehicle Ve is increased, and the processor 13 may change the control strategy to following without lateral control to prevent collision with the entering vehicle O5. In this way, the processor 13 may modify the expected driving path of the host vehicle Ve in a direction that follows the entering vehicle O5 within the intersection. The processor 13 may newly set the expected driving region area_3 to follow the rear of the entering vehicle O5 according to the changed control strategy and display the new expected driving region on the display 11. For example, the processor 13 may adjust at least one of the brightness, color, and chroma of the expected driving region area_3 according to a change in an acceleration/deceleration control amount of the host vehicle Ve.

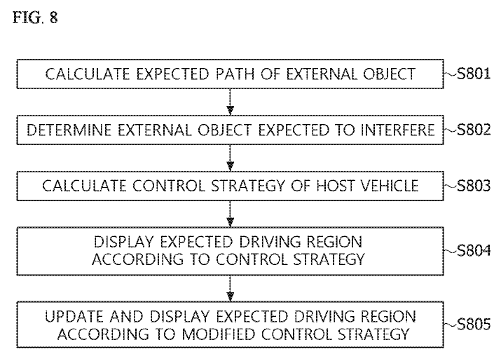

FIG. 8 is a flowchart of an example method of controlling a vehicle. Referring to FIG. 8, a processor may determine an expected path of an external object based on the type of the external object and movement information about the external object included in external object recognition information (S801).

The processor may determine an external object expected to interfere based on the expected path of the external object and the vehicle driving information about the host vehicle (S802).

The processor may determine a control strategy based on the expected path of the external object and the vehicle driving information about the host vehicle. For example, for the external object expected to interfere, the processor may determine a first strategy of following without lateral control, a second strategy of overtaking without lateral control, a third strategy of following by performing lateral control, or a fourth strategy of overtaking by performing lateral control (S803).

The processor may visually display an expected driving region in which the host vehicle is expected to travel according to the control strategy through the display. In this way, the processor may adjust at least one of an area, color, contrast, brightness, shape, and chroma of the expected driving region according to the expected path of the external object and the control strategy (S804).

The processor may modify the control strategy by considering the external object recognition information collected in real time and the driving information about the host vehicle, and update and display the expected driving region according to the modified control strategy (S805).

The term “unit” used in the example embodiment(s) refers to software components or hardware components such as a field-programmable gate array (FPGA) or an application specific integrated circuit (ASIC), and “unit” performs certain functions. However, the “unit” is not limited to software or hardware. The “unit” may be configured to reside in an addressable storage medium, or may be configured to reproduce one or more processors. Therefore, for example, “unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions provided in the components and the “unit” may be combined into smaller numbers of components and “units,” or may be further divided into additional components and “units.” Furthermore, the components and “units” may be implemented to reproduce one or more CPUs in a device or a security multimedia card.

According to the present disclosure, there is provided a vehicle control device including a display, a sensor unit, one or more processors, and a memory storing one or more programs executed by the one or more processors, in which the sensor unit collects vehicle driving information about a host vehicle and external object recognition information, and the processor is configured to determine an external object expected to interfere with a driving path of the host vehicle based on the vehicle driving information about the host vehicle and the external object recognition information, determine a control strategy of the host vehicle for the external object expected to interfere, and visually display an expected driving region in which the host vehicle is determined to travel according to the control strategy through the display.

The processor may determine an expected path of the external object based on a type of the external object and movement information about the external object included in the external object recognition information.

The processor may determine the external object expected to interfere based on the expected path of the external object and the vehicle driving information about the host vehicle.

The processor may adjust at least one of an area, color, contrast, brightness, shape, and chroma of the expected driving region according to the expected path of the external object and the control strategy.

The processor may be configured to modify the control strategy by adjusting the expected path of the external object according to the movement information about the external object and adjust at least one of an area, color, contrast, brightness, shape, and chroma of the expected driving region according to the modified control strategy.

The processor may determine the control strategy based on the expected path of the external object and the vehicle driving information about the host vehicle.

The processor may determine the control strategy by combining whether to perform lateral control, whether to perform overtaking, and whether to perform following, on the external object expected to interfere.

The processor may determine a first strategy of following without the lateral control, a second strategy of overtaking without the lateral control, a third strategy of following by performing the lateral control, or a fourth strategy of overtaking by performing the lateral control for the external object expected to interfere.

The processor may adjust the control strategy by considering a road speed limit and regulation information.

The processor may adjust the control strategy by considering a preset driving purpose.

According to the present disclosure, there is provided a vehicle control method performed by a computing device having one or more processors and a memory storing one or more programs executed by the one or more processors, including determining, by the processor, an external object expected to interfere with a driving path of a host vehicle based on vehicle driving information about the host vehicle and external object recognition information that are collected by a sensor unit, determining, by the processor, a control strategy of the host vehicle for the external object expected to interfere, and visually displaying, by the processor, an expected driving region in which the host vehicle is determined to travel according to the control strategy through a display.

The processor may calculate an expected path of the external object based on a type of the external object and movement information about the external object included in the external object recognition information.

The processor may determine the external object expected to interfere based on the expected path of the external object and the vehicle driving information about the host vehicle.

The processor may adjust at least one of an area, color, contrast, brightness, shape, and chroma of the expected driving region according to the expected path of the external object and the control strategy.

The processor may modify the control strategy by adjusting the expected path of the external object according to the movement information about the external object, and adjust at least one of an area, color, contrast, brightness, shape, and chroma of the expected driving region according to the modified control strategy.

The processor may determine the control strategy based on the expected path of the external object and the vehicle driving information about the host vehicle.

The processor may determine the control strategy by combining whether to perform lateral control, whether to perform overtaking, and whether to perform following, on the external object expected to interfere.

The processor may determine a first strategy of following an external object expected to interfere with the vehicle without lateral control, a second strategy of overtaking without lateral control, a third strategy of following by performing lateral control, or a fourth strategy of overtaking by performing lateral control.

The processor may adjust the control strategy by considering a road speed limit and regulation information.

The processor may adjust the control strategy by considering a preset driving purpose.

With a vehicle control device and method according to the present disclosure, it is possible to intuitively display a control strategy of an autonomous vehicle.

In addition, it is possible to determine a driving strategy of a vehicle by considering interference of an external object and visually display the determined driving strategy.

In addition, it is possible to update and display a driving strategy of a vehicle in real time when the driving strategy is changed.

Although one or more example embodiments of the present disclosure have been described herein, it is understood that those skilled in the art may make various changes and modifications to the present disclosure without departing from the spirit and scope of the present disclosure set forth in the claims below.

What is claimed is:

1. A vehicle control device for a vehicle, the vehicle control device comprising:
a display device;
one or more sensors configured to obtain vehicle driving information about the vehicle and external object information about an external object;
one or more processors; and
a memory storing at least one instruction that is configured, when executed by the one or more processors communicating with the memory, to cause the vehicle control device to:
determine, based on the vehicle driving information and the external object information, that a probability score indicating likelihood of the external object interfering with a driving path of the vehicle is above a threshold value;
determine, based on the probability score being above the threshold value, a vehicle control strategy of the vehicle; and
display, via the display device and based on the vehicle control strategy, a planned autonomous driving path of the vehicle.

2. The vehicle control device of claim 1, wherein the external object information comprises movement information about the external object, and wherein the at least one instruction is configured, when executed by the one or more processors communicating with the memory, to further cause the vehicle control device to:
determine, based on an object type of the external object and based on the movement information about the external object, an expected movement path of the external object.

3. The vehicle control device of claim 2, wherein the at least one instruction is configured, when executed by the one or more processors communicating with the memory, to further cause the vehicle control device to:
determine, based on the expected movement path of the external object and the vehicle driving information, the probability score.

4. The vehicle control device of claim 2, wherein the at least one instruction is configured, when executed by the one or more processors communicating with the memory, to cause the vehicle control device to display the planned autonomous driving path of the vehicle by:
determining, based on the expected movement path of the external object and the vehicle control strategy, at least one of an area, color, contrast, brightness, shape, or chroma of the planned autonomous driving path being displayed via the display device.

5. The vehicle control device of claim 2, wherein the at least one instruction is configured, when executed by the one or more processors communicating with the memory, to cause the vehicle to display the planned autonomous driving path of the vehicle by:
adjusting, based on updated external object information about the external object, the expected movement path of the external object;
modifying, based on the adjusted expected movement path of the external object, the vehicle control strategy; and
adjusting, based on the modified vehicle control strategy, at least one of an area, color, contrast, brightness, shape, or chroma of the planned autonomous driving path being displayed via the display device.

6. The vehicle control device of claim 2, wherein the at least one instruction is configured, when executed by the one or more processors communicating with the memory, to cause the vehicle to determine the vehicle control strategy of the vehicle by:
determining the vehicle control strategy further based on the expected movement path of the external object and the vehicle driving information.

7. The vehicle control device of claim 1, wherein the at least one instruction is configured, when executed by the one or more processors communicating with the memory, to cause the vehicle to determine the vehicle control strategy by:
determining at least one of:
whether to perform lateral control of the vehicle,
whether to overtake the external object, or
whether to follow the external object.

8. The vehicle control device of claim 1, wherein the at least one instruction is configured, when executed by the one or more processors communicating with the memory, to cause the vehicle to determine the vehicle control strategy by:
determining at least one of:
a first vehicle control strategy comprising following the external object without performing lateral control of the vehicle,
a second vehicle control strategy comprising overtaking the external object without performing the lateral control of the vehicle,
a third vehicle control strategy comprising following the external object and performing the lateral control of the vehicle, or
a fourth vehicle control strategy comprising overtaking the external object and performing the lateral control of the vehicle.

9. The vehicle control device of claim 1, wherein the at least one instruction is configured, when executed by the one or more processors communicating with the memory, to cause the vehicle to determine the vehicle control strategy by:
adjusting, based on at least one of a road speed limit or a traffic regulation, the vehicle control strategy.

10. The vehicle control device of claim 1, wherein the at least one instruction is configured, when executed by the one or more processors communicating with the memory, to cause the vehicle to determine the vehicle control strategy by:
adjusting, based on a driving purpose associated with the vehicle, the vehicle control strategy.

11. A method performed by an apparatus of a vehicle, the method comprising:
obtaining, via one or more sensors of the vehicle, vehicle driving information about the vehicle and external object information about an external object;
determining, based on the vehicle driving information and the external object information, that a probability score indicating likelihood of the external object interfering with a driving path of the vehicle is above a threshold value;
determining, based on the probability score being above the threshold value, a vehicle control strategy of the vehicle; and
displaying, via a display device and based on the vehicle control strategy, a planned autonomous driving path of the vehicle.

12. The method of claim 11, wherein the external object information comprises movement information about the external object, and wherein the method further comprises:
determining, based on an object type of the external object and based on the movement information about the external object, an expected movement path of the external object.

13. The method of claim 12, further comprising:
determining, based on the expected movement path of the external object and the vehicle driving information, the probability score.

14. The method of claim 12, wherein the displaying of the planned autonomous driving path of the vehicle comprises:
determining, based on the expected movement path of the external object and the vehicle control strategy, at least one of an area, color, contrast, brightness, shape, or chroma of the planned autonomous driving path being displayed via the display device.

15. The method of claim 12, wherein the displaying of the planned autonomous driving path of the vehicle comprises:
adjusting, based on updated external object information about the external object, the expected movement path of the external object;
modifying, based on the adjusted expected movement path of the external object, the vehicle control strategy; and
adjusting, based on the modified vehicle control strategy, at least one of an area, color, contrast, brightness, shape, or chroma of the planned autonomous driving path being displayed via the display device.

16. The method of claim 12 wherein the determining of the vehicle control strategy of the vehicle comprises:
determining the vehicle control strategy further based on the expected movement path of the external object and the vehicle driving information.

17. The method of claim 11, wherein the determining of the vehicle control strategy comprises:
determining at least one of:
whether to perform lateral control of the vehicle,
whether to overtake the external object, or
whether to follow the external object.

18. The method of claim 11, wherein the determining of the vehicle control strategy of the vehicle comprises:
determining at least one of:
a first vehicle control strategy comprising following the external object without performing lateral control of the vehicle,
a second vehicle control strategy comprising overtaking the external object without performing the lateral control of the vehicle,
a third vehicle control strategy comprising following the external object and performing the lateral control of the vehicle, or
a fourth vehicle control strategy comprising overtaking the external object and performing the lateral control of the vehicle.

19. The method of claim 17, wherein the determining of the vehicle control strategy of the vehicle comprises:
adjusting, based on at least one of a road speed limit or a traffic regulation, the vehicle control strategy.

20. The method of claim 17, wherein the determining of the vehicle control strategy of the vehicle comprises:
adjusting, based on a driving purpose associated with the vehicle, the vehicle control strategy.
